(19) United States
(12) Patent Application Publication
(10) Pub. No.: US 2025/0150417 A1
(43) Pub. Date: May 8, 2025

(54) METHOD, APPARATUS, DEVICE AND STORAGE MEDIUM FOR SESSION INTERACTION

(71) Applicant: Beijing Zitiao Network Technology Co., Ltd., Beijing (CN)

(72) Inventors: Yiyu HE, Beijing (CN); Jiangwen WANG, Beijing (CN); Qingyu ZHANG, Beijing (CN); Zhong WANG, Beijing (CN)

(21) Appl. No.: 18/941,931

(22) Filed: Nov. 8, 2024

(30) Foreign Application Priority Data
Nov. 8, 2023 (CN) 202311483255.3
Nov. 22, 2023 (CN) 202311570378.0

(51) Int. Cl. H04L 51/063; H04L 51/02

(52) U.S. Cl. CPC H04L 51/063; H04L 51/02

(57) ABSTRACT

Embodiments of the disclosure provide a method, an apparatus, a device and a storage medium for session interaction. The method includes: presenting, in a session between a user and a digital assistant, a reply message of the digital assistant for a session message of the user, the reply message including a summary content matching the session message; and in response to detecting the detail viewing operation on the summary content, presenting a detail content including an extension to the summary content. In this way, flexible viewing of the summary content and the detail content of the content can be supported in the session with the digital assistant, thereby improving an extended presentation manner of complex content.

### CROSS-REFERENCE

This application claims priority to Chinese Patent Application No. 202311483255.3, filed on Nov. 8, 2023, and entitled “METHOD, APPARATUS, DEVICE, AND STORAGE MEDIUM FOR SESSION INTERACTION” which claims priority to Chinese Patent Application No. 202311570378.0, filed on Nov. 22, 2023, and entitled “METHOD, APPARATUS, DEVICE, AND STORAGE MEDIUM FOR SESSION INTERACTION,” the entire contents of each of which are incorporated herein by reference.

### FIELD

Example embodiments of the present disclosure generally relate to the field of computer, and in particular, to a method, an apparatus, a device, and a computer-readable storage medium for session interaction.

### BACKGROUND

With the development of information technologies, various terminal devices may provide various services to people in aspects of work and life, etc. Applications providing a service may be deployed in the terminal device. The terminal device presents the corresponding content through a user interface of the application, realizes interaction with a user, and meets various types of requirements of the user. Therefore, a rich application interaction interface is an important means of improving user experience. The terminal device or application may provide functions such as a digital assistant to the user to assist the user in using the terminal device or application. How to improve the flexibility of interaction between a user and a digital assistant is a technical problem to be explored currently.

### SUMMARY

In a first aspect of the present disclosure, a method of session interaction is provided. The method comprises presenting, in a session between a user and a digital assistant, a reply message of the digital assistant for a session message of the user, the reply message comprising summary content matching the session message; and in response to detecting the detail viewing operation on the summary content, presenting detail content comprising an extension to the summary content.

In a second aspect of the present disclosure, an apparatus for session interaction is provided. The apparatus comprises a message presentation module configured to present, in a session between a user and a digital assistant, a reply message of the digital assistant for a session message of the user, the reply message comprising summary content matching the session message; and a detail presentation module configured to, in response to detecting a detail viewing operation on the summary content, present detail content comprising an extension to the summary content.

In a third aspect of the present disclosure, an electronic device is provided. The electronic device comprises at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The computer-readable storage medium has a computer program stored thereon, and the computer program, when executed by a processor, implements the method of the first aspect.

It should be understood that the content described in this section is not intended to limit the key features or important features of the embodiments of the present disclosure, nor is it intended to limit the scope of the present disclosure. Other features of the present disclosure will become apparent from the following description.

### BRIEF DESCRIPTION OF THE DRAWINGS

The above and other features, advantages, and aspects of various embodiments of the present disclosure will become more apparent from the following detailed description in conjunction with the accompanying drawings. In the drawings, the same or similar reference signs refer to the same or similar elements, in which:

FIG. 1 illustrates a schematic diagram of an example environment in which embodiments of the present disclosure can be implemented;

FIG. 2 illustrates a flowchart of an example process for session interaction according to some embodiments of the present disclosure;

FIGS. 3A and 3B illustrate examples of different content views according to some embodiments of the present disclosure;

FIG. 4 illustrates a flowchart of a signal flow for session interaction according to some embodiments of the present disclosure;

FIG. 5 illustrates a flowchart of a process for session interaction according to some embodiments of the present disclosure;

FIG. 6 illustrates a schematic structural block diagram of an apparatus for session interaction according to some embodiments of the present disclosure; and

FIG. 7 illustrates a block diagram of an electronic device in which one or more embodiments of the present disclosure may be implemented.

### DETAILED DESCRIPTION

The embodiments of the present disclosure will be described in more detail below with reference to the accompanying drawings. Although some embodiments of the present disclosure are illustrated in the drawings, it should be understood that the present disclosure can be implemented in various forms and should not be construed as being limited to the embodiments set forth herein. Rather, these embodiments are provided for a more thorough and complete understanding of the present disclosure. It should be understood that the drawings and the embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “an embodiment” or “the embodiment” should be understood as “at least one embodiment”. The term “some embodiments” should be understood as “at least some of the embodiments”. Other explicit and implicit definitions may also be included below.

Herein, unless explicitly stated. “in response to A” performing a step is not intended that this step is performed immediately after “A”, but may include one or more intermediate steps.

It is to be understood that the data involved in the technical solution, including but not limited to the data itself, the obtaining, usage, storage or deletion of the data, should comply with the requirements of corresponding laws and regulations and relevant provisions.

It is to be understood that, before using the technical solutions disclosed in the various embodiments of the present disclosure, the related user shall be informed of the type, the scope of use, and use scenarios and so on of information involved in the present disclosure in an appropriate manner in accordance with relevant laws and regulations, and the related user's authorization shall be obtained. The related user may include any type of subject of rights, e.g. individuals, enterprises, organizations.

For example, in response to receiving an active request from a user, prompt information is sent to the related user to explicitly prompt the related user that an operation requested by the related user will require to obtain and use information of the related user, so that the related user can autonomously select, according to the prompt information, whether to provide the information to software or hardware, such as an electronic device, an application program, a server, or a storage medium that performs the operations of the technical solutions of the present disclosure.

As an optional but non-limiting implementation, in response to receiving an active request of the user, the prompt information is sent to the user, for example, in the form of a pop-up window, in which the prompt information may be presented in the form of text. In addition, the pop-up window may further carry a selection control for the user to select “agree” or “not agree” to provide the personal information to the electronic device.

It should be understood that the above process for notifying and obtaining the user's authorization is merely illustrative, and do not limit the implementations of the present disclosure, and other approaches that meet the relevant laws and regulations may also be applied to the implementations of the present disclosure. In the embodiments of the present disclosure, enabling of the functions related to the digital assistant, the acquired data, the processing and storing modes of data, and the like shall all be authorized in advance by the user and other subjects of rights associated with the user, and shall comply with related laws and regulations and protocol rules agreed among the subject of rights.

As used herein, the term “model” may learn an association relationship between respective inputs and outputs from training data such that a corresponding output may be generated for a given input after training is done. Generation of the model may be based on machine learning techniques. Deep learning is a machine learning algorithm that processes inputs and provides corresponding outputs by using multiple layers of processing units. Neural network model is an example of the model based on deep learning. As used herein, the “model” may also be referred to as a “machine learning model,” “learning model,” “machine learning network,” or “learning network,” and these terms may be used interchangeably herein.

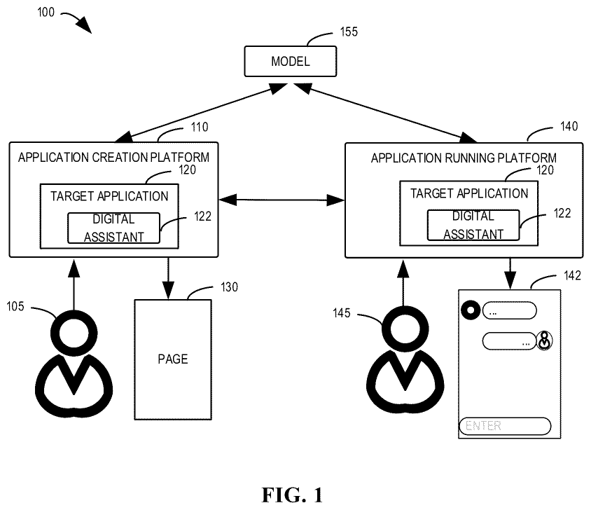

FIG. 1 illustrates a schematic diagram of an example environment 100 in which embodiments of the present disclosure can be implemented. The environment 100 relates to an application creation platform 110 and an application running platform 140.

As shown in FIG. 1, the application creation platform 110 may provide the user 105 with an application creation and publishing environment. The user 105 may be referred to as an application creation user, creator. In some embodiments, the application creation platform 110 may be a low code platform that provides a set of tools for application creation. The application creation platform 110 may support visual development of various applications, so that the developer may skip the manual coding process, accelerate the development cycle and reduce the cost of the application. The application creation platform 110 may support any suitable platform for a user to develop one or more types of applications, for example, may include an Application-Platform-as-a-Service (aPaaS) based platform. Such a platform can support efficient development of applications by users, and implement operations, such as application creation, application function adjustment, etc.

The application creation platform 110 may be deployed locally on the terminal device of the user 105 and/or may be supported by the server device. For example, the terminal device of the user 105 may run a client of the application creation platform 110, and the client may support interaction between the user and the application creation platform 110 provided by the server. In case the application creation platform 110 runs locally on the user's terminal device, the user 105 may directly interact with the local application creation platform 110 by using the terminal device. In case the application creation platform 110 runs on the server device, the server device may provide service to the client running in the terminal device based on the communication connection with the terminal device. The application creation platform 110 may present a respective page 130 to the user 105 based on the operation of the user 105 to output, to the user 105, and/or receive, from the user 105, information related to the application creation.

In some embodiments, the application creation platform 110 may be associated to a respective database, wherein the data or information needed by the application creation process supported by the application creation platform 110 is stored. For example, the database may store code and description information, etc. corresponding to each functional module for constituting the application. The application creation platform 110 may also perform operations such as invoking, adding, deleting, updating, and the like on functional modules in the database. The database may also store operations that may be performed on different functional blocks. For example, in a scenario in which an application is to be created, the application creation platform 110 may invoke, from a database, a corresponding functional block to build the application.

In an embodiment of the present disclosure, the user 105 may create a target application 120 on the application creation platform 110 as needed, and publish the target application 120. The target application 120 may be published to any suitable application running platform 140 as long as the application running platform 140 is able to support the running of the target application 120. After publication, the target application 120 may be used by one or more users 145 for operation. The user 145 may be referred to as a terminal user of the target application 120. In some embodiments, the target application 120 may include or be implemented as a digital assistant 122.

The digital assistant 122 may be configured to have an intelligent session. In the example shown in FIG. 1, the digital assistant 122 may be integrated into the target application 120 as a part of the target application 120 to assist in performing task processing within the target application 120. In other examples, the digital assistant 122 may be configured as an application that runs independently, such as a web application or other types of application. In such an example, the digital assistant 122 and the target application 120 may be considered as the same application. The digital assistant 122 is provided to assist the user in various types of task processing requirements in different applications and scenarios. During interaction with the digital assistant 122, the user inputs an interaction message and in response to the user input, the digital assistant 122 provides a reply message. Generally, the digital assistant 122 can support users to input questions in natural language and perform tasks and provide replies based on understanding of natural language input and logical reasoning capabilities.

In some embodiments, digital assistant 122 may interact with the user as a contact of user 145. For example, the digital assistant 122 may be implemented in an instant messaging (IM) application. The digital assistant 122 may interact with the user 145 in a single-chat session with the user 145. In some embodiments, the digital assistant 122 may interact with multiple users in a group-chat session that comprises multiple users. In the following, some embodiments of the present disclosure are described by taking mainly an IM scenario as an example, but a session between a user and the digital assistant 122 may be triggered in any other appropriate interaction scenarios, for example, the digital assistant 122 may be triggered to interact with the user in other applications (for example, a document application, a calendar application, a schedule application, etc.), and a session between the user and the digital assistant may be presented.

For each user 145, the client of the application running platform 140 may present, in a client interface, an interaction window 142 of the target application 120 or the digital assistant 122, such as a session window with the digital assistant 122. User 145 may input a session message in the session window, and target application 120 may determine a reply message of digital assistant 122 based on created configuration information and present it to the user in the interaction window 142. In some embodiments, the interaction message with the target application 120 may include a multimodal form of messages, such as a text message (e.g., natural language text), a voice message, an image message, a video message, etc., depending on the configuration of the target application 120.

Similar to the application creation platform 110, the application running platform 140 may be deployed locally on the terminal device of each user 145, and/or may be supported by the server device. For example, the terminal device of the user 145 may run a client of the application running platform 140, and the client may support interaction between the user and the application running platform 140 provided by the server. In case the application running platform 140 runs locally on the user's terminal device, the user 145 may directly interact with the local application running platform 140 by using the terminal device. In case the application running platform 140 runs on the server device, the server device may provide service to the client running in the terminal device based on the communication connection with the terminal device. The application running platform 140 may present a corresponding application page to user 145 based on the operation of user 145 to output, to the user 145, and/or receive, from the user 145, information related to application usage.

In some embodiments, implementation of at least partial function of the target application 120, and/or implementation of at least partial function of the digital assistant 122 in the target application 120 may be based on a model. In the creation or running process of the target application 120, one or more models 155 may be invoked. In the target application 120, the digital assistant 122 may utilize the model 155 to understand the user input and provide a reply to the user based on an output of the model 155.

In the creation process, test of the target application 120 by the application creation platform 110 needs to utilize model 155 to determine that the running result of the target application 120 meets expectations. In the running process, in response to different operating requests of the user of the target application 120, the application running platform 140 may need to utilize model 155 to determine a response result to the user.

Although shown as separated from the application creation platform 110 and the application running platform 140, the one or more models 155 may run on the application creation platform 110 and/or the application running platform 140, or other remote servers. In some embodiments, the model 155 may be a machine learning model, a deep learning model, a learning model, a neural network, or the like. In some embodiments, the model may be based on a language model (LM). The language model can have question- answer capability by learning from a large amount of corpus. The model 155 may also be based on other suitable models.

The application creation platform 110 and/or the application running platform 140 may run on appropriate electronic devices. The electronic device herein may be any type of device having computing capability, comprising a terminal device or a server device. The terminal device may be any type of mobile terminal, fixed terminal, or portable terminal, comprising a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, comprising accessories and peripherals of these devices, or any combination thereof. The server device may include, for example, a computing system/server, such as a mainframe, an edge computing node, a computing device in a cloud environment, or the like. In some embodiments, the application creation platform 110 and/or the application running platform 140 may be implemented based on cloud services.

It should be understood that the structure and function of the environment 100 are described for exemplary purposes only and do not imply any limitation to the scope of the present disclosure. For example, while FIG. 1 shows a single user interacting with the application creation platform 110 and a single user interacting with the application running platform 140, in practice multiple users may access the application creation platform 110 to each create a digital assistant, and each digital assistant may be used to interact with multiple users.

In conventional interaction with a digital assistant, the digital assistant interacts with the user mainly in the form of IM message. Message content tends to be presented in the form of text, picture, and is difficult to carry contents for complex charts, forms, etc. In some application designs, developers also design to carry complex message contents such as charts, forms, etc. by card messages. However, in practical applications, it is also desirable to have a more flexible message presentation mode in view of different contents and different user terminal interfaces.

According to embodiments of the present disclosure, an improved session interaction solution is provided. In this solution, in a session between a user and a digital assistant, a reply message of the digital assistant for a session message of the user is presented, wherein the reply message comprises summary content matching the session message. In response to detecting a detail viewing operation on the summary content, detail content comprising an extension to the summary content is presented. In this way, flexible viewing of the summary content and the detail content of the content can be supported in the session with the digital assistant, thereby improving the expanded presentation mode of complex content. The solution provides a way for combining detail viewing page of the content with IM message, the presentation view of the content can be selected according to the specific interaction scene, and the content desired by the user can be flexibly presented.

Some example embodiments of the present disclosure will be described in detail below with reference to examples of the accompanying drawings. It should be understood that the pages shown in the drawings are merely examples, and in practice, there may exist various page designs. Individual graphical elements in a page may have different arrangements and different visual representations, one or more of which may be omitted or replaced, and there may be one or more other elements. Embodiments of the present disclosure are not limited in this regard.

The session interaction process described in the embodiments of the present disclosure may be implemented on an application running platform, a terminal device installed with an application running platform, and/or a server corresponding to an application running platform. For discussion purposes, the following examples are described from the perspective of an application running platform, for example, the application running platform 140 as shown in FIG. 1. The user interface presented by the application running platform 140 may be presented via a terminal device of the user 145, and the application running platform 140 may receive the user input via the terminal device of the user 145.

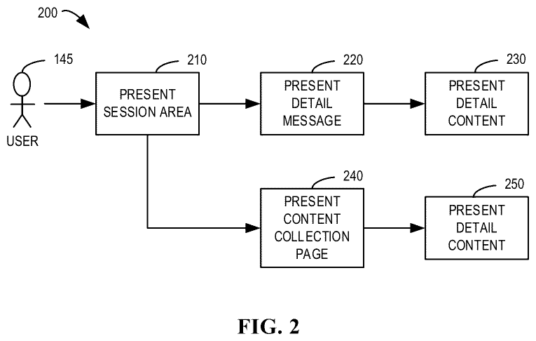

FIG. 2 illustrates a flowchart of an example process 200 for session interaction according to some embodiments of the present disclosure. Process 200 may be implemented in the application running platform 140 at a terminal device of the user 145.

At block 210, the terminal device presents a session with the digital assistant 122 according to the trigger of the user 145. Depending on the specific application configuration, the digital assistant 122 of the target application 120 may be invoked or triggered by various appropriate ways and provide a corresponding session.

At block 220, in the session of the user 145 with the digital assistant 122, the terminal device presents a reply message of the digital assistant 122 for the session message of the user 145. The reply message comprises summary content that matches the session message of the user 145. During the interaction of user 145 with digital assistant 122, digital assistant 122 may determine a corresponding reply message for the session message from user 145.

In some embodiments, the session message of user 145 may include a user input characterized in natural language, such as user input provided by text, speech. In some embodiments, the session message of the user 145 may also be initiated by triggering a shortcut instruction. In response to detecting the session message of the user 145, the digital assistant 122 may understand the user requirements in the session message by means of a model, and determine content matching the user requirements.

In some embodiments, at least the summary content in the reply message provided by the digital assistant 122 is the content determined to correspond to the user requirements in the session message of the user 145. For example, if the user identifies a desire to view a client data report through the session message, the digital assistant 122 may analyze the user intent and requirement by the session message from the user and determine or generate content meeting the user requirement from a corresponding data source. In some embodiments, the digital assistant 122 may utilize the model 155 to help to complete determination of user requirement, content determination, and the like.

In embodiments of the present disclosure, the message presented in the session of user 145 with digital assistant 122 comprises the summary content. The summary content may be presented, for example, in a summary view. In some embodiments, the summary content may include a summary of the target content that matches the user requirement. In some embodiments, the summary content presented in the reply message is obtained adaptively according to user intent. Further, the capability of the model may be used to identify which part(s) of the target content are to be put into the summary content for the current user intent.

At block 230, in response to detecting the detail viewing operation on the summary content, the terminal device presents detail content, the detail content comprising an extension to the summary content. The detail content may be presented, for example, in a detail view. Unlike the summary content, more content details may be provided to a user in the detail content for viewing and/or interaction by a user. In some embodiments, the detail content may be presented in a larger presentation area rather than being presented in a layout of messages in the session, enabling a larger amount of more comprehensive content to be shown to the user. In some embodiments, the detail content comprises at least summary content, and may also include more detailed contents. In some embodiments, in addition to summary content that is better matched to the user's session message, the remaining content in the detail content may be considered lower in match degree with the user's session message. In some embodiments, the detail content may also be determined to be content that matches the user's session requirement, but cannot be completely presented to the user in the session message due to limitations to message show in the session.

In some embodiments, a part of the target content that is presented concurrently in the summary content and in the detail content may be presented in the same style, e.g., both by means of form and/or chart. In some embodiments, the part of the content presented concurrently in the summary content and in the detail content may also be displayed in different modes of presentation. For example, in a session message, the summary content may be presented to the user in a form or plain text. The detail content may include one or more forms, one or more types of charts (e.g., histograms, graphs, pie charts, etc.), multi-dimensional data tables, and the like to be presented to the user.

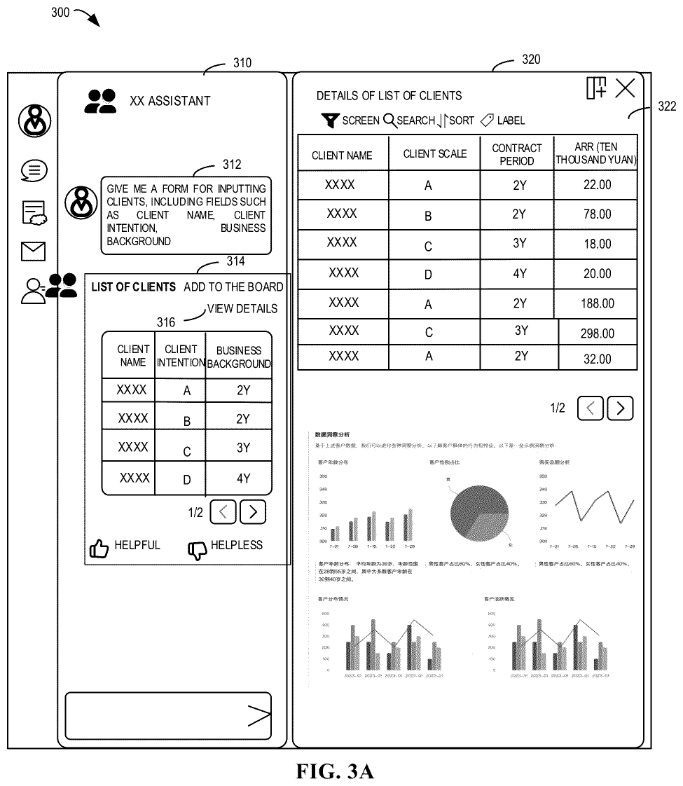

FIG. 3A illustrates an example page 300 of different views according to some embodiments of the present disclosure. Page 300 presents a session 310 between the user and the digital assistant including interaction messages of the user with the digital assistant, for example, comprising the session message 312 from the user and the reply message 314 from the digital assistant. In this example, reply message 314 presents the summary content desired by the user.

In some embodiments, the reply message of the digital assistant may be presented in a card form, such as the example shown in FIG. 3A. The message content in a card message may be presented to the user in the manner of rich text such as text, form, chart, or etc.

In some embodiments, the reply message of the digital assistant may include a detail viewing entry, such as the detail viewing entry 316 in the reply message 314 shown in FIG. 3A. If a trigger for the detail viewing entry, for example, a click operation is detected, the terminal device detects a detail viewing operation on the summary content. Accordingly, in response to detecting the detail viewing operation on the summary content, the terminal device presents the detail content, such as the detail content 322 shown in FIG. 3A. In some embodiments, other ways for triggering a detail viewing operation may be provided in addition to the trigger for the detail viewing entry. For example, it is possible to jump from the summary content to the detail content by clicking or otherwise triggering any area of the reply message, or by clicking or otherwise triggering the summary content in the reply message. Embodiments of the present disclosure are not limited in this regard.

In some embodiments, in response to detecting the detail viewing operation on the summary content, the terminal device provides a data presentation area and presents the detail content in the data presentation area. The data presentation area herein may be separated from the session. As shown in FIG. 3A, the data presentation area 320 may be presented in parallel with the session 310, i.e., the session 310 and the data presentation area 320 may be presented in a paging manner in the user's client interface. Of course, in addition to the presentation manner shown in FIG. 3A, in some embodiments, the data presentation area 320 may be presented to cover the session 310, or it is possible to jump from the session 310 to the data presentation area 320 in a page jump manner. In this way, a larger presentation area can be provided for providing the detail content to the user.

According to an embodiment of the invention, a graphical user interface (GUI) page capable of carrying a complex chart and a form is provided in a session between a user and a digital assistant, and the interaction capability of the digital assistant and the user experience are improved.

In some embodiments, a user may be allowed to collect the reply message. In such an implementation, in response to the collection operation on the reply message, the terminal device adds summary content and the corresponding detail content to the content collection page of the user 145. The content collection page may be a content specific page, or may be an integrated page of different contents collected by the user 145. In some embodiments, such a content collection page may also be referred to as a content board page or a data board page. In the content collection page, summary content and detail content may also be presented separately according to the thumbnail view and the detail view. That is, summary content is presented in the content collection page. With continued reference to the process 200 of FIG. 2, in block 240, the terminal device detects a trigger operation on the content collection page, and presents the content collection page. Summary content is presented in a content collection page.

At block 250, in response to detecting a detail viewing operation on the summary content in the content collection page, the terminal device presents the detail content. In some embodiments, the content collection page may include a detail viewing entry. If a trigger for the detail viewing entry, for example, a click operation is detected, the terminal device detects a detail viewing operation on the summary content. Accordingly, in response to detecting the detail viewing operation on the summary content, the terminal device presents the detail content, such as the detail content 330 in the page 302 shown in FIG. 3B. In some embodiments, other ways for triggering a detail viewing operation may be provided in addition to the trigger for the detail viewing entry. For example, it is possible to jump from the summary content to the detail content by clicking or otherwise triggering any area of the reply message, or by clicking or otherwise triggering summary content in the reply message. Embodiments of the present disclosure are not limited in this regard.

In some embodiments, in the detail content, one or more interaction controls for the detail content may be presented in addition to providing more contents. For example, multiple interaction controls 324 are provided in the detail content 322 of FIG. 3A, and multiple interaction controls 332 are provided in the detail content 330 of FIG. 3B. Each interaction control corresponds to a specific interaction operation on part or all of the detail content, such as the screening operation, the searching operation, the sorting operation, the labeling operation, and the like shown in FIG. 3A and FIG. 3B. In response to triggering an interaction control in the one or more interaction controls, the terminal device performs an operation corresponding to the triggered interaction control on at least a part of the detail content. By providing the interactive control in the detail content, the user may be allowed to conveniently and quickly perform specific operations on the detail content. In this way, the user can not only switch from the summary content to the detail content to view more content parts as needed, but also perform interaction on the content.

In some embodiments, the digital assistant 122 may help to complete session interactions with the user via the model 155. The model 155 may be utilized to determine whether the content will be presented differently in the manner of summary content and detail content, as well as how to distinguish the content parts included in the two views, respectively.

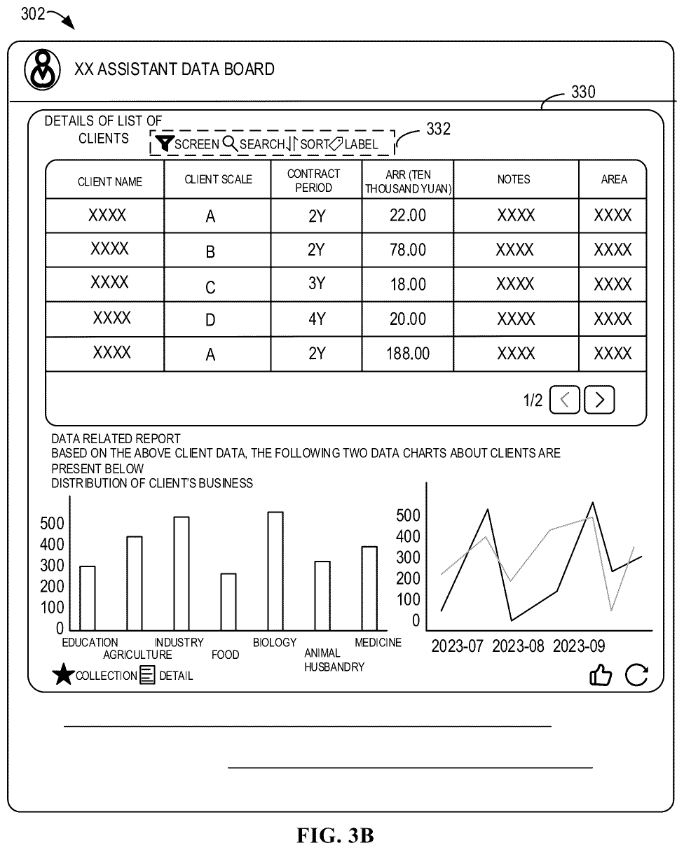

FIG. 4 illustrates a flowchart of a signal flow 400 for session interaction according to some embodiments of the present disclosure. The signal flow 400 involves the terminal device 402 of the user 145, the server device 404 of the target application 120, and the model service 406. The terminal device 402, the server device 404, and the model service 406 may correspond to an application running platform 140 of the target application 120.

As shown in FIG. 4, the terminal device 402 sends (410) a session message of the user 145 to the server device 404. The server device 404 delivers (420) the session message of the user 145 to the model service 406. The model service 406 may be configured to invoke one or more models 155. In response to an invoke of the model 155, the model 155 may determine a processing result for the session message based on the session message and based on knowledge and data related to the target application 120. The processing result indicates at least the target content that can be presented to the user, and may specifically indicate: a part of the target content included in the summary content, and an entirety of the target content in the detail content. That is, in the processing result returned by the model 155, in addition to indicating the target content, the content part to be included respectively in the summary view and the detail view is specifically identified. The processing result returned by the model 155 may include an indication of a summary portion and an indication of a detail portion (also referred to as a main portion) in the target content. The summary portion will be presented in the summary content, while the summary portion and detail portion together will be presented in the detail content. Accordingly, presentation of the summary content and presentation of the detail content are based on processing results. In this way, the content part that needs to be presented in the session message (that is, summary content) and the content part that needs to be presented after the user actively initiates a detail viewing request (that is, detail content) in the target content may be automatically determined by means of the model.

In some embodiments, model processing and message rendering in the session between user 145 and digital assistant 122 may be performed in parallel. As shown in FIG. 4, when the processing result provided by the model service 406 has not been received, the server device 404 may load (430) rendering of the reply message of the digital assistant 122. After receiving (435) the processing result from the model service 406, the server device 404 returns (440) a reply message to the terminal device 402, wherein the reply message comprises summary content, that is, the content represented as the summary portion in the processing result.

In some embodiments, if the processing result of the model 155 does not indicate the content part to be presented in the summary content and the content part to be presented in the detail content, the reply message of the digital assistant 122 will not distinguish views to present the target content indicated by the processing result. That is, by means of the judgment capability of the model, it is possible to determine which complex content needs to distinguish between the summary content and the detail content, and which content may be directly presented to the user at a time in the reply message of the digital assistant 122.

In some embodiments, in response to receiving the processing result from the model service 406, the detail content is stored together with the identifier (ID) of the reply message. In some embodiments, the detail content and the ID of the reply message are stored in a data store accessible to the server device 404, or may be stored in a data store accessible to the terminal device 402.

With continued reference to FIG. 4, assume that the detail content and the ID of the reply message are stored in a data store accessible to the server device 404. The terminal device 402 initiates (450) a detail viewing operation for the summary content. In some embodiments, the detail viewing operation comprises an ID of the reply message. In response to the detail viewing operation, the server device 404 obtains (460) the stored detail content based on the ID of the reply message. In some embodiments, the detail viewing operation may be initiated for a reply message in the session of the user with the digital assistant, such as a detail viewing entry in the reply message triggered by the user. In some embodiments, the detail viewing operation may be initiated in the content collection page for summary content in the content collection page. In this case, since the summary content collected in the content collection page is also associated with the corresponding reply message, the detail viewing operation may still carry the ID of the corresponding reply message.

In some embodiments, the detail content may be stored persistently, or may be stored for a predetermined period of time. In any case, when the user initiates a detail viewing operation, the detailed content may be quickly presented to the user without interacting with the model service 406 or the specific model 155 again. The server device 404 returns (470) the detail content to the terminal device 402, which comprises a summary portion and a detail portion. The server device 404 may further render (480) the detail content and provide the rendering result to the terminal device 402 for presentation.

In this way, at the terminal device 402, more details of the content may be shown to the user based on the detail viewing request of the user, comprising presenting complex content to the user in a richer graphical display manner.

According to an embodiment of the present disclosure, a session interaction manner in which a graphical user interface (GUI) page is combined with an IM message may be further provided on the basis of a card message manner (for example, a message supporting a chart and a form), so that the content desired by the user is presented more flexibly and more closely to the scene.

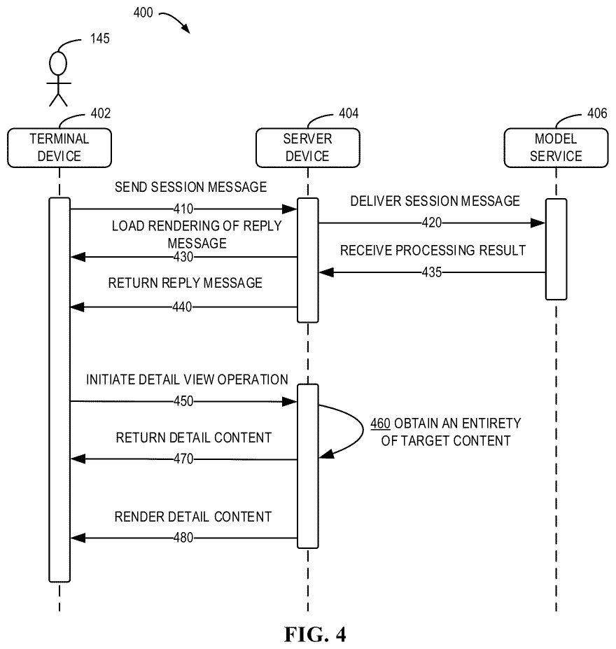

FIG. 5 illustrates a flowchart of a process 500 for session interaction in accordance with some embodiments of the present disclosure. The process 500 may be implemented at the application running platform 140. The process 500 is described below with reference to FIG. 1.

At block 510, the application running platform 140 presents, in the session of the user with the digital assistant, a reply message of the digital assistant for the user's session message, the reply message comprising summary content that matches the session message.

At block 520, in response to detecting a detail viewing operation on the summary content, the application running platform 140 presents detail content comprising an extension to the summary content.

In some embodiments, the process 500 further comprises: providing the session message of the user to a model; and receiving, from the model, a processing result for the session message, the processing result indicating a summary content and the detail content. For example, the model may determine a target content that can be presented to the user and indicate a part of the target content included in the summary content, and an entirety of the target content in the detail content. In some embodiments, presentation of the summary content and presentation of the detail content are based on processing results.

In some embodiments, the processing result indicates a target content that matches the session message and comprises an indication of the summary portion and an indication of the detail portion in the target content. In some embodiments, the summary content comprises a summary portion in the target content, and the detail content comprises a summary portion and a detail portion in the target content.

In some embodiments, the process 500 further comprises, in response to receiving the processing result, storing the detail content together with the identifier of the reply message.

In some embodiments, presenting the detail content comprises providing a data presentation area, presenting the detail content in the data presentation area. The data presentation area is separated from the session.

In some embodiments, the reply message comprises a detail viewing entry. In some embodiments, and presenting the detail content comprises: detecting a detail viewing operation on the summary content based on a trigger for the detail viewing entry; and in response to detecting the detail viewing operation on the summary content, presenting the detail content.

In some embodiments, the reply message is presented in a card form.

In some embodiments, the process 500 further comprises: in response to a collection operation on the reply message, adding summary content and detail content to a content collection page of the user; presenting the summary content in the content collection page; and in response to detecting a detail viewing operation on the summary content in the content collection page, presenting the detail content.

In some embodiments, the process 500 further comprises: presenting, in the detail content, one or more interaction controls for the detail content; and in response to a trigger for an interaction control in the one or more interaction controls, performing an operation corresponding to the triggered interaction control on at least a part of the detail content.

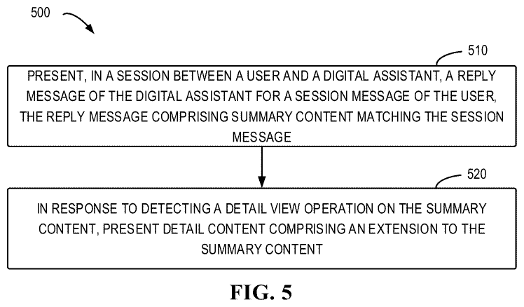

FIG. 6 illustrates a schematic structural block diagram of an apparatus 600 for session interaction, in accordance with some embodiments of the present disclosure. The apparatus 600 may be, for example, implemented in or included in the application running platform 140. Various modules/components in the apparatus 600 may be implemented by hardware, software, firmware, or any combination thereof.

As shown, the apparatus 600 comprises a message presenting module 610 configured to present, in a session between a user and a digital assistant, a reply message of the digital assistant for a session message of the user, the reply message comprising summary content matching the session message. The apparatus 600 further comprises a detail presenting module 620 configured to, in response to detecting a detail viewing operation on the summary content, present detail content comprising an extension to the summary content.

In some embodiments, the apparatus 600 further comprises: a message providing module configured to provide a session message of the user to the model; and a result receiving module configured to receive a processing result for the session message from the model, the processing result indicating summary content and detail content. In some embodiments, presentation of the summary content and presentation of the detail content are based on processing results.

In some embodiments, the processing result indicates target content that matches the session message and comprises an indication of the summary portion and an indication of the detail portion in the target content. In some embodiments, the summary content comprises a summary portion in the target content, and the detail content comprises a summary portion and a detail portion in the target content.

In some embodiments, the apparatus 600 further comprises: a content storage module configured to, in response to receiving the processing result, store the detail content together with the identifier of the reply message.

In some embodiments, the detail presenting module 620 is configured to: provide a data presentation area, and presenting the detail content in the data presentation area. The data presentation area is separated from the session.

In some embodiments, the reply message comprises a detail viewing entry. In some embodiments, the detail presenting module 620 is configured to: detect a detail viewing operation on the summary content based on a trigger for the detail viewing entry; and in response to detecting the detail viewing operation on the summary content, present the detail content.

In some embodiments, the reply message is presented in a card form.

In some embodiments, the apparatus 600 further comprises: a content collection module configured to add the summary content and the detail content to a content collection page of the user, in response to a collection operation on the reply message; a summary presenting module configured to present the summary content in the content collection page; and a detail content module configured to, in response to detecting a detail viewing operation on the summary content in the content collection page, present the detail content.

In some embodiments, the apparatus 600 further comprises: a control presenting module configured to present, in the detail content, one or more interaction controls for the detail content; and an operation performing module configured to, in response to a trigger for an interaction control in the one or more interaction controls, perform an operation corresponding to the triggered interaction control on at least a part of the detail content.

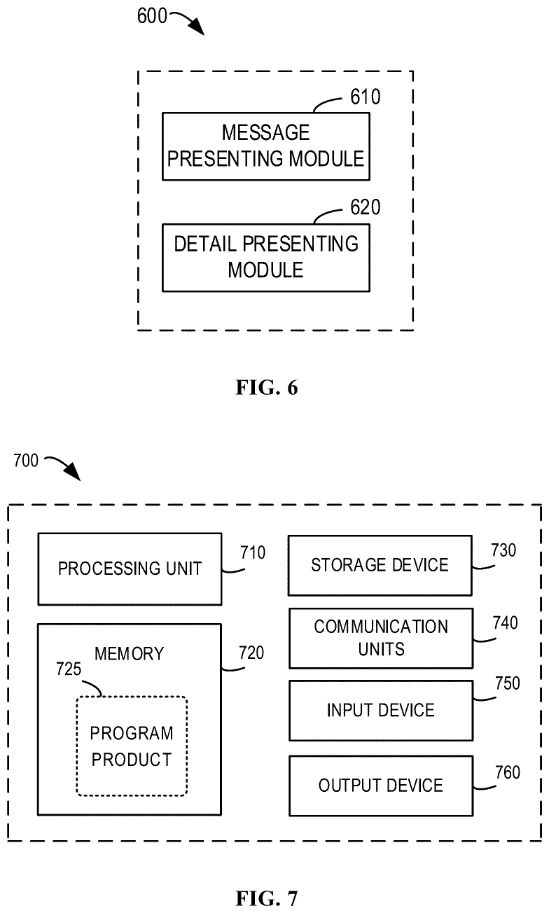

FIG. 7 illustrates a block diagram of an electronic device 700 in which one or more embodiments of the present disclosure may be implemented. It should be understood that the electronic device 700 in FIG. 7 is shown for merely illustrative purpose, and should not limit the functionality and scope of the embodiments described herein. The electronic device 700 shown in FIG. 7 may include or be implemented as the application creation platform 110, the application running platform 140 in FIG. 1, the terminal device 402, server device 404 in FIG. 1, or the apparatus 700 shown in FIG. 7.

As shown in FIG. 7, the electronic device 700 is in the form of a general-purpose computing device. Components of the electronic device 700 may include, but are not limited to, one or more processors or processing units 710, a memory 720, a storage device 730, one or more communications units 740, one or more input devices 750, and one or more output devices 760. The processing unit 710 may be a physical or virtual processor and can perform various processing according to a program stored in the memory 720. In a multiprocessor system, a plurality of processing units executes computer executable instructions in parallel, so as to improve the parallel processing capability of the electronic device 700.

The electronic device 700 typically includes a plurality of computer storage medium. Such media may be any available media that are accessible by the electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, a magnetic disk, or any other medium that can be used to store information and/or data and that can be accessed within the electronic device 700.

The electronic device 700 may further include additional detachable/undetachable, volatile/nonvolatile storage medium. Although not shown in FIG. 7, a magnetic disk drive for reading from or writing to a detachable, nonvolatile magnetic disk, such as a “floppy disk” and an optical disk drive for reading from or writing to a detachable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. Additionally, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown), such as a storage device, a display device, or the like through the communication unit 740 as desired, and communicate with one or more devices that enable a user to interact with the electronic device 700, or communicate with any device (e.g., a network card, a modem, or the like) that enables the electronic device 700 to communicate with one or more other electronic devices. Such communication may be performed via an input/output (I/O) interface (not shown).

According to an example implementation of the present disclosure, a computer readable storage medium is provided, on which computer-executable instructions is stored, wherein the computer-executable instructions are executed by a processor to implement the method described above. According to an example implementation of the present disclosure, a computer program product is also provided, which is tangibly stored on a non-transitory computer readable medium and includes computer-executable instructions that are executed by a processor to implement the method described above.

Aspects of the present disclosure are described herein with reference to flowcharts and/or block diagrams of methods, apparatus, devices and computer program products implemented in accordance with the present disclosure. It should be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, when executed via the processing unit of the computer or other programmable data processing apparatus, create means for implementing the functions/actions specified in one or more blocks of the flowcharts and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture that includes instructions which implement various aspects of the functions/actions specified in one or more blocks of the flowcharts and/or block diagrams.

The computer readable program instructions may be loaded onto a computer, other programmable data processing apparatus, or other devices, causing a series of operational steps to be performed on the computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the present disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method of session interaction, comprising:
presenting, in a session between a user and a digital assistant, a reply message of the digital assistant for a session message of the user, the reply message comprising summary content matching the session message; and
in response to detecting a detail viewing operation on the summary content, presenting detail content comprising an extension to the summary content.

2. The method of claim 1, further comprising:
providing the session message of the user to a model; and
receiving, from the model, a processing result for the session message, the processing result indicating the summary content and the detail content,
wherein the presentation of the summary content and the presentation of the detail content are based on the processing result.

3. The method of claim 2, wherein the processing result indicates target content that matches the session message and comprises an indication of a summary portion and an indication of a detail portion in the target content,
wherein the summary content comprises the summary portion in the target content, and the detail content comprises the summary portion and the detail portion in the target content.

4. The method of claim 2, further comprising:
in response to receiving the processing result, storing the detail content together with an identifier of the reply message.

5. The method of claim 1, wherein presenting the detail content comprises:
providing a data presentation area, and presenting the detail content in the data presentation area,
wherein the data presentation area is separated from the session.

6. The method of claim 1, wherein the reply message comprises a detail viewing entry, and wherein presenting the detail content comprises:
detecting a detail viewing operation on the summary content based on a trigger for the detail viewing entry; and
in response to detecting the detail viewing operation, presenting the detail content.

7. The method of claim 1, wherein the reply message is presented in a card form.

8. The method of claim 1, further comprising:
in response to a collection operation on the reply message, adding the summary content and the detail content to a content collection page of the user;
presenting the summary content in the content collection page; and
in response to detecting the detail viewing operation on the summary content in the content collection page, presenting the detail content.

9. The method of claim 1, further comprising:
presenting, in the detail content, one or more interaction controls for the detail content; and
in response to a trigger for an interaction control in the one or more interaction controls, performing an operation corresponding to the triggered interaction control on at least a part of the detail content.

10. An electronic device comprises:
at least one processing unit; and
at least one memory coupled to the at least one processing unit and storing instructions for execution by the at least one processing unit, the instructions, when executed by the at least one processing unit, causing the electronic device to perform at least:
presenting, in a session between a user and a digital assistant, a reply message of the digital assistant for a session message of the user, the reply message comprising summary content matching the session message; and
in response to detecting a detail viewing operation on the summary content, presenting detail content comprising an extension to the summary content.

11. The electronic device of claim 10, wherein the electronic device is further caused to perform:
providing the session message of the user to a model; and
receiving, from the model, a processing result for the session message, the processing result indicating the summary content and the detail content,
wherein the presentation of the summary content and the presentation of the detail content are based on the processing result.

12. The electronic device of claim 11, wherein the processing result indicates target content that matches the session message and comprises an indication of a summary portion and an indication of a detail portion in the target content,
wherein the summary content comprises the summary portion in the target content, and the detail content comprises the summary portion and the detail portion in the target content.

13. The electronic device of claim 11, wherein the electronic device is further caused to perform:
in response to receiving the processing result, storing the detail content together with an identifier of the reply message.

14. The electronic device of claim 10, wherein presenting the detail content comprises:
providing a data presentation area, and presenting the detail content in the data presentation area,
wherein the data presentation area is separated from the session.

15. The electronic device of claim 10, wherein the reply message comprises a detail viewing entry, and wherein presenting the detail content comprises:
detecting a detail viewing operation on the summary content based on a trigger for the detail viewing entry; and
in response to detecting the detail viewing operation, presenting the detail content.

16. The electronic device of claim 10, wherein the reply message is presented in a card form.

17. The electronic device of claim 10, wherein the electronic device is further caused to perform:
in response to a collection operation on the reply message, adding the summary content and the detail content to a content collection page of the user;
presenting the summary content in the content collection page; and
in response to detecting the detail viewing operation on the summary content in the content collection page, presenting the detail content.

18. The electronic device of claim 10, wherein the electronic device is further caused to perform:
presenting, in the detail content, one or more interaction controls for the detail content; and
in response to a trigger for an interaction control in the one or more interaction controls, performing an operation corresponding to the triggered interaction control on at least a part of the detail content.

19. A non-transitory computer-readable storage medium having a computer program stored thereon, the computer program being executable by a processor to implement a method of session interaction, comprising:
presenting, in a session between a user and a digital assistant, a reply message of the digital assistant for a session message of the user, the reply message comprising summary content matching the session message; and
in response to detecting a detail viewing operation on the summary content, presenting detail content comprising an extension to the summary content.
